(19) United States
(12) Patent Application Publication
(10) Pub. No.: US 2018/0236906 A1
(43) Pub. Date: Aug. 23, 2018

(54) ADJUSTMENT DEVICE FOR A REAR SEAT BENCH, AND A SEAT ARRANGEMENT

(71) Applicant: Adient Luxembourg Holding S.à.r.l., Luxembourg (LU)

(72) Inventors: Wolfgang PLUTA, Heiligenmoschel (DE); Christian WOLF, Katzenbach (DE); Heinrich HAMMANN, Teschenmoschel (DE)

(21) Appl. No.: 15/514,938

(22) PCT Filed: Oct. 8, 2015
(86) PCT No.: PCT/EP2015/073243

§ 371 Date: Mar. 28, 2017

(30) Foreign Application Priority Data
Oct. 8, 2014 (DE) 10 2014 220 405.4

(51) Int. Cl. B60N 2/30; B60N 2/36

(52) U.S. Cl. CPC B60N 2/3011; B60N 2/36

(57) ABSTRACT

An adjustment device (1) for a rear seat bench (2) includes a seat part (3) and a divided backrest (4) that has at least one car body-side rest segment (4.1) and at least one adjacent rest segment (4.2). At least one of the car body-side rest segment (4.1) and the adjacent rest segment (4.2) is foldable from a use position into a non-use position, or vice versa, when in an unlocked state. A spring unit (7) is arranged between the adjacent rest segments (4.1, 4.2) and is functionally connected to the rest segments (4.1, 4.2) in a mechanical manner. A seat arrangement is also provided including such an adjustment device (1).

### CROSS REFERENCE TO RELATED APPLICATIONS

This application is a United States National Phase Application of International Application PCT/EP2015/073243, filed Oct. 8, 2015, and claims the benefit of priority under 35 U.S.C. § 119 of German Application 10 2014 220 405.4, filed Oct. 8, 2014, the entire contents of which are incorporated herein by reference.

### FIELD OF THE INVENTION

The invention relates to an adjustment device for a rear seat bench, comprising a seat part and a divided backrest with at least one body-side backrest segment and at least one adjacent backrest segment, wherein at least one of the backrest segments in the released state is foldable from a use position into a non-use position, or vice versa.

### BACKGROUND OF THE INVENTION

Furthermore, the invention relates to a seat arrangement for a vehicle, comprising such an adjustment device for a rear seat bench.

Adjustment devices for rear seat benches which comprise the seat part and the divided backrest are known in general from the prior art. In order to be able to adjust the backrest segments of the backrest, locking units and what are referred to as backrest compensation springs are provided, wherein a backrest compensation spring is provided for each backrest segment. A backrest compensation spring serves to at least partially compensate for a weight of the backrest during folding over of the same.

### SUMMARY OF THE INVENTION

An object It is the object of the present invention to specify an adjustment device, which is improved in relation to the prior art, for a rear seat bench, and an improved seat arrangement.

The adjustment device for a rear seat bench comprises a seat part and a divided backrest with at least one in particular body-side or freestanding backrest segment which is fixed on the substructure, and at least one adjacent backrest segment, wherein at least one of the backrest segments in the released state is foldable from a use position into a non-use position or vice versa. According to the invention, a spring unit is arranged between the adjacent backrest segments, said spring unit being in mechanical interaction with said backrest segments.

The advantages obtained with the invention consist in particular in that, in comparison to the prior art, only one spring unit is in interaction with two adjacent backrest segments. This results in a saving on components, by omitting a second spring unit which is customary in the prior art, a reduction in weight and a significant saving on costs.

In a development of the adjustment device according to the invention, the spring unit is pretensioned by means of the mechanical interaction in a locked state of the adjacent backrest segments into the use position thereof, and therefore, when at least one backrest segment is released, a spring force resulting from said pretensioning drives said backrest segment out of a locking region. It is therefore ensured that after the at least one backrest segment has been driven out of the locking following the release, a user does not have to actuate a release element further in order to grasp the at least one backrest segment and to fold same over further.

In another development of the adjustment device according to the invention, when the adjacent backrest segment is released from the use position, the spring unit relaxes in such a manner that the released, adjacent backrest segment moves relative to the body-side backrest segment which remains locked. The adjacent backrest segment is preferably a through-loading feature. It is therefore possible for the user to fold over the through-loading feature separately, wherein folding over is assisted within a certain pivoting range by means of the relaxation of the spring unit. Depending on the dimensioning of the spring unit and/or materials used therefor, it is possible to adjust the pretensioning in such a manner that said pretensioning acts over the entire pivoting range of the adjacent backrest segment and brings about full folding over of the adjacent backrest segment without the user intervening in an assisting manner.

A refinement of the adjustment device according to the invention provides that when the body-side backrest segment is released from the use position, the spring unit relaxes in such a manner that the two backrest segments move.

The two backrest segments preferably move only about a pivoting range into a substantially vertical position since, after this position is exceeded during the pivoting movement into the non-use position, the spring unit is tensioned again in an opposite direction.

The adjacent backrest segment is locked in the body-side backrest segment by means of a locking unit, as a result of which said backrest segments are fixedly connected to each other. The spring unit exerts the pretensioning on the adjacent backrest segment, the pretensioning being transmitted to the body-side backrest segment by means of the locking unit.

If the body-side backrest segment is unlocked, the pretensioning therefore acts uniformly on the two backrest segments, as a result of which said backrest segments are driven out of the body-side locking region.

The user is therefore assisted when folding over the backrest segments and, because of the spring force, the backrest segments are prevented from dropping back into the body-side locking. In order to realize locking of the backrest segments in the body-side locking, the user has to apply a force which acts counter to a spring force.

According to a further refinement of the adjustment device according to the invention, the spring unit is pretensioned in the non-use position by means of the mechanical interaction in a locked state of the body-side backrest segment.

The spring unit is tensionable in two directions and has a zero passage in a spring force progression over a defined angular range of rotation. It is therefore possible to assist the user during the folding over of the backrest segments into the use position and into the non-use position.

If the body-side backrest segment is in the locked use position, it is possible to shift the adjacent backrest segment in the released state between use position and non-use position. If, however, the body-side backrest segment is released on the body side, on account of the locking unit between the backrest segments a pivoting angle of the adjacent backrest segment is restricted, depending on a position of the body-side backrest segment, in such a manner that the adjacent backrest segment is only pivotable between the non-use position and a position of the body-side backrest segment.

If the body-side backrest segment is in the non-use position, the adjacent backrest segment is always also in the non-use position, wherein the locking unit locks the two backrest segments to each other, and a fitting which is arranged on the body-side backrest segment locks the body-side backrest segment and therefore the adjacent backrest segment in the non-use position.

In an advantageous manner, it is possible to use the mechanical interaction by a pretensioned spring unit to assist the flipping up of the at least one body-side backrest segment from the non-use position after the fitting is released.

Another refinement of the adjustment device according to the invention provides that the adjacent backrest segments each have a driver on which the spring unit engages or is engageable in order to produce the interaction.

If the spring unit is tensioned by at least one driver, for example during a pivoting movement of the body-side backrest segment into the non-use position, at least one driver produces contact with the spring unit, i.e. the driver acts on the spring unit. If the spring unit is relaxed, the latter acts on the at least one driver.

The engagement of the backrest segments in the spring unit and an interaction associated therewith is realized in a simple and cost-effective manner by means of the driver.

In another development of the adjustment device according to the invention, the spring unit is a spiral spring which is tensionable in two directions. The spiral spring is an evenly wound bending spring which is provided to absorb a torque loading of the backrest segments and to store or output same as spring force. It is therefore possible in an advantageous manner, because of the small dimensions of a spiral spring, to ensure a compact construction of the spring unit. By means of the angled spring end which is bringable into engagement with the drivers, a simple and cost-effective transmission of torque from the backrest segments to the spring unit and vice versa is realized.

The spring unit therefore brings about assistance in raising at least one backrest segment from the use position with respect to the zero passage of the spring force or from the non-use position with respect to the zero passage.

In a refinement of the adjustment device according to the invention, the body-side driver, which is arranged on the body-side backrest segment, has, at a spring-side end, two opposite stops engaging in the spring unit. The first stop contacts the spring unit during a pivoting movement from the use position into the non-use position, and therefore said stop tensions the spring unit in a first direction. The second stop contacts the spring unit during a pivoting movement from the non-use position into the use position, and therefore said stop tensions the spring unit in a second direction which is opposed to the first direction. Within the pivoting range in which the spring unit has the zero passage, none of the two stops contacts the spring unit.

In other words: the two stops are arranged spaced apart from each other forming a clearance. In this case, the spring unit runs against the stops in the region of a reversal from the use position into the non-use position or vice versa.

The clearance limits the working travel of the spring unit. The reduction in the working travel of the spring unit increases the overall service life thereof and provides the possibility of improved spring characteristics and the selection thereof.

For example, in the case of a spring unit with a steep characteristic curve, a working travel of 40° would possibly result in too large a final torque. By a skilled choice of the clearance or freewheel, an intervention can be made within limits by, for example, only an actual working travel of 30 being realized by a 10° clearance and optimized spring characteristics being configured.

This is of importance in particular if the spring unit is operated in two directions for different requirements or uses. For example, the first requirement, in which the spring unit acts forward, would be a comfort assistance during adjustment of the backrest. The second requirement, in which the spring unit acts rearward, would be lifting of the spring unit out of a locked position, in particular out of a locking in a loading platform position. On the other hand, should the resulting force in the loading platform be too high, the spring unit at a given loading platform angle would be stored without play over its working travel.

The body-side driver is of substantially horizontally U-shaped design in the direction of the spring unit, wherein two opposite stops are formed in the interior of the U shape. By means of a design of the body-side driver with a first stop and an opposite second stop, between which the angled spring end is arranged, a simple transmission of torque is possible, wherein an outlay in production of the body-side driver, in particular of the first stop and of the second stop, is very low.

In another refinement of the adjustment device according to the invention, the adjacent driver which is arranged on the adjacent backrest segment has, at a spring-side end, a third stop, and therefore the adjacent driver tensions the spring unit during the pivoting movements of the adjacent backrest segment from the non-use position into the use position while the body-side backrest segment remains locked on the body side. A simple transmission of torque is therefore possible. In particular, the pretensioning of the spring unit can therefore be ensured in the use position of the two backrest segments.

The seat arrangement for a vehicle, comprising an adjustment device according to the invention for a rear seat bench, affords the advantage of realizing a rear seat bench construction space which is smaller than in the prior art and of obtaining a significant saving on components.

Exemplary embodiments of the invention are explained in more detail with reference to drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic front view of a detail of a rear seat bench;

FIG. 2 is a schematic perspective view of a spring unit in a first state;

FIG. 3 is a schematic side view of the spring unit shown in FIG. 2;

FIG. 4 is a schematic perspective view of the spring unit in a second state;

FIG. 5 is a schematic side view of the spring unit shown in FIG. 4;

FIG. 6 is a schematic side view of the spring unit shown in FIG. 4, and a detail of a backrest; and

FIG. 7 is a schematic side view of the spring unit in a third state.

### DESCRIPTION OF THE PREFERRED EMBODIMENTS

Referring to the drawings, mutually corresponding parts are provided with the same reference signs throughout the figures.

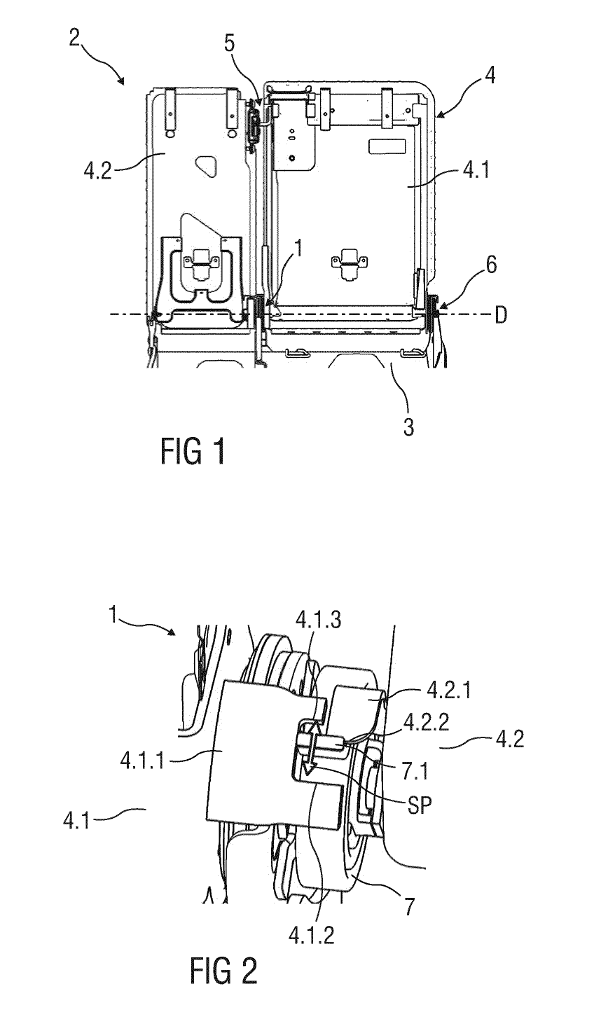

FIG. 1 shows, in an exemplary embodiment of the adjustment device 1 according to the invention for a rear seat bench 2, a detail of a front view of the rear seat bench 2, comprising a seat part 3 and a backrest 4.

The backrest 4 comprises a backrest segment 4.1 and an adjacent backrest segment 4.2, here a through-loading feature. The backrest segment 4.1 can be fastened, for example on the body side, to the vehicle floor or to the C pillar. Alternatively, the backrest segment 4.1 can be fastened and locked, for example on the substructure side, to a longitudinally and/or vertically displaceable seat substructure, and can therefore be freestanding. The backrest segments 4.1, 4.2 are divided transversely in a y direction in a ratio of 20:40. The backrest 4 is pivotable about an axis of rotation D from a substantially vertical use position, for example a normal seat position, into a substantially horizontal or lying non-use position, for example a folded over position enlarging the loading space, and vice versa.

The adjacent backrest segment 4.2 is lockable in the body-side backrest segment 4.1 by means of a locking unit 5, wherein a positional fixing in the use position is therefore ensured for the adjacent backrest segment 4.2 if the body-side backrest segment is locked in the use position. By means of a fitting 6 which is arranged on the body side on the axis of rotation D, a body-side locking of the body-side backrest segment 4.1 is possible in the use position and in the non-use position.

Various states of the folding over of the backrest segments 4.1, 4.2 are adoptable.

If the body-side backrest segment 4.1 is in the use position, the adjacent backrest segment 4.2 in a released state is foldable from the use position into the non-use position and vice versa independently of the body-side backrest segment 4.1.

The folding over of the body-side backrest segment 4.1 from the use position into the non-use position always results in folding over of the adjacent backrest segment 4.2 because of engagement of the locking unit 5.

The folding over of the adjacent backrest segment 4.2 from the non-use position into the use position is not possible if the body-side backrest segment 4.1 is positioned in the non-use position since, because of the locking unit 5, the body-side backrest segment 4.1 forms a pivot-limiting stop for the adjacent backrest segment 4.2. However, separate folding over of the body-side backrest segment 4.1 from the non-use position into the use position is possible if the locking unit 5 is released and the adjacent backrest segment 4.2 remains in the non-use position.

FIG. 2 shows a perspective view of a spring unit 7 in a first state, wherein the body-side backrest segment 4.1 comprises a body-side driver 4.1.1 of U-shape design, and the adjacent backrest segment 4.2 comprises an adjacent driver 4.2.1 of single-armed design.

In the exemplary embodiment illustrated, the spring unit 7 is a “spiral spring” with torque loading and is produced from an evenly wound spring steel strip with an approximately rectangular cross section and is designed as a backrest compensation spring, wherein the latter at least partially compensates for the weight of the backrest segments 4.1, 4.2 in the possible positions of the backrest 4.

Alternatively, it is possible to provide the spring unit 7 as a torsion spring or as another suitable type of spring.

The spring unit 7 is tensionable in two directions and has a zero passage in a spring force progression over a defined angular range of rotation, in which zero passage a spring force is neither output nor absorbed.

An inner end of the spring unit 7 is supported on the vehicle floor side by means of a vehicle-mounted holding element (not illustrated) on the vehicle floor, wherein, for example, the inner end is hooked into a slot in the holding element. For example, the inner end of the spring unit 7 is connected to the vehicle floor between the two backrest segments 4.1, 4.2 via one of the floor-mounted fitting parts of one of the fittings of the backrest segments 4.1, 4.2 and is fastened non-rotatably to said vehicle floor.

An outer spring end 7.1 of the spring unit 7 is of angled design in such a manner that the spring unit 7 is or is bringable into interaction with the drivers 4.1.1, 4.2.1.

The body-side driver 4.1.1 is of substantially horizontally U-shaped design and, on the inner sides of the U shape, has a first stop 4.1.2 and an opposite second stop 4.1.3 which contact the spring end 7.1 arranged between the stops 4.1.2, 4.1.3 when the adjacent backrest segment 4.2 is pivoted, and therefore tension the spring unit 7 during the pivoting movement of the adjacent backrest segment 4.2 from the use position into the non-use position and vice versa.

The two stops 4.1.2, 4.1.3 are arranged spaced apart from each other here forming a clearance SP. By this means, the spring unit 7 runs against the stops 4.1.2, 4.1.3 in the region of a reversal from the use position into the non-use position or vice versa, with the clearance SP reducing the working travel of the spring unit 7.

In the exemplary embodiment, the spring unit 7 acts forward here for a first use in order to permit comfort assistance during the adjustment of the backrest segment 4.2. In a second use, the spring unit 7 acts rearward in order to permit the spring unit 7 to be lifted out of a locked position, in particular out of locking in a loading platform position.

The adjacent driver 4.2.1 has, at a spring-side end which is of substantially single-armed design, a third stop 4.2.2, and therefore the latter acts on the spring end 7.1 and tensions the spring unit 7 during a pivoting movement of the adjacent backrest segment 4.2 from the non-use position into the use position.

In the illustrated state of the adjustment device 1, the backrest segments 4.1, 4.2 are arranged in the use position, wherein the third stop 4.2.2 of the adjacent driver 4.1.1 pretensions the spring end 7.1 and therefore the spring unit 7. This pretensioning assists a release operation of the adjacent backrest segment 4.2 since the pretensioning drives the adjacent backrest segment 4.2 out of the locking unit 5 and therefore makes it easier for the user to fold over same into the non-use position.

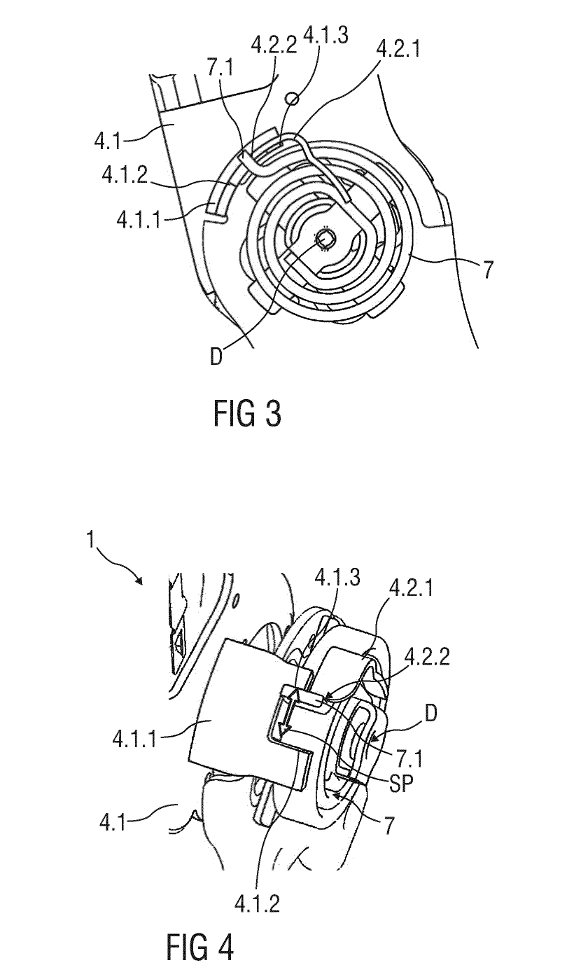

FIG. 3 shows a side view of the spring unit 7 shown in FIG. 2.

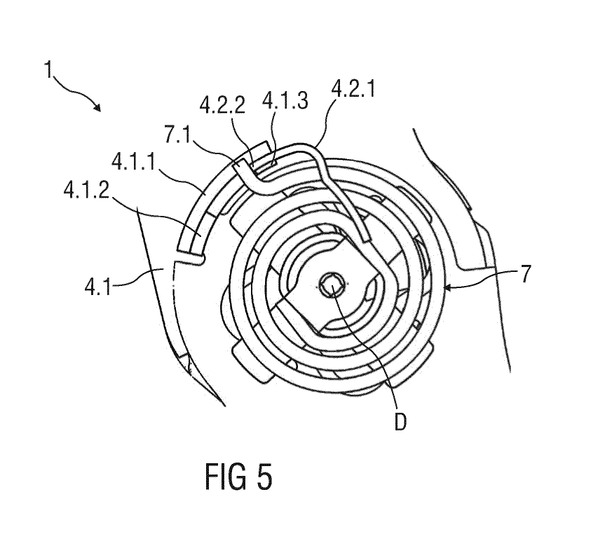

FIG. 4 shows a perspective view of the spring unit 7 in a second state, wherein the locking unit 5 (not illustrated) is released and the adjacent backrest segment 4.2, because of the pretensioning described in FIG. 2, has been driven out of the locking unit 5, and therefore the adjacent backrest segment 4.2 is foldable from the use position into the non-use position. The body-side backrest segment 4.1 is locked on the body side in the use position.

The spring unit 7 is relaxed by an amount of the described pretensioning, wherein further relaxation is locked by means of the spring end 7.1 being supported against the second stop 4.1.3 of the body-side driver 4.1.1 since the body-side backrest segment 4.1 is locked on the body side by means of the fitting 6 (not illustrated).

FIG. 5 shows a side view of the spring unit 7 shown in FIG. 4.

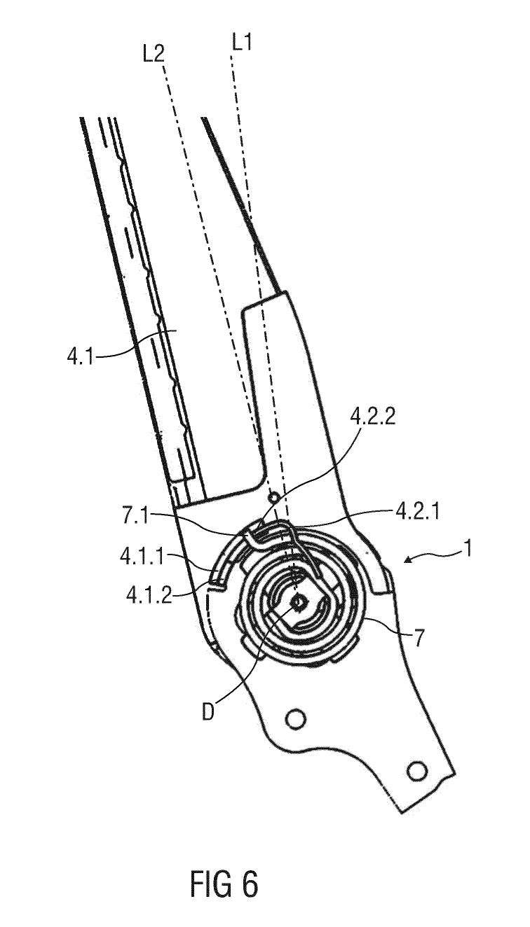

FIG. 6 shows the side view of the spring unit 7 shown in FIG. 4, and a detail of the backrest 4. A first line L1 schematically shows the position, described in FIG. 4, of the released adjacent backrest segment 4.2 which has been driven out of the locking unit 5 because of the pretensioning. The pretensioning drives the adjacent backrest segment 4.2 here out of the use position by an angle of 5°.

A second line L2 schematically shows the position of the body-side backrest segment 4.1 in the use position, said backrest segment being locked on the body side by means of the fitting 6. Depending on dimensions and requirements, the spring unit 7 can furthermore exert further pretensioning on the body-side driver 4.1.1 and can therefore assist the user after release of the body-side locking of the body-side backrest segment 4.1 since the body-side backrest segment 4.1 is at least partially raised.

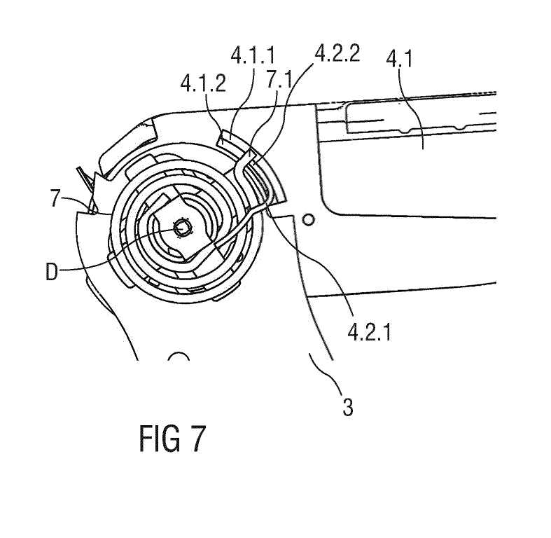

FIG. 7 shows a side view of the spring unit 7 in a third state in which the body-side locking is released and the backrest segments 4.1, 4.2 are in the non-use position.

For assistance for the user when the backrest segments 4.1, 4.2 are flipped up out of the non-use position into the use position, it is provided that the spring force progression has the zero passage during the pivoting movement. That is to say the spring unit 7 relaxes during the pivoting movement from the use position into the non-use position by, for example, an angle of 20° by means of engagement of the spring end 7.1 on the first stop 4.1.2 until said spring unit is completely relaxed and has the zero passage of the spring force. During the further pivoting, for example by 10°, the spring unit then has the zero passage in which the spring unit 7 remains substantially relaxed and there is no engagement between spring end 7.1 and the stops 4.1.2, 4.1.3. Subsequently, the spring unit 7 is tensioned by the further pivoting movement of the body-side backrest segment 4.1 into the non-use position, by means of engagement of the second stop 4.1.3 on the spring end 7.1. This tensioning requires an action of force by the user by the user pressing the body-side backrest segment 4.1 downward. If the body-side backrest segment 4.1 is locked in the non-use position by means of the fitting 6, the spring unit 7 exerts pretensioning on the second stop 4.1.2 by means of the spring end 7.1, said pretensioning, when the body-side backrest segment 4.1 is released, being an assisting effect for the user when flipping said backrest segment up.

While specific embodiments of the invention have been shown and described in detail to illustrate the application of the principles of the invention, it will be understood that the invention may be embodied otherwise without departing from such principles.

1. An adjustment device for a rear seat bench, comprising a seat part and a divided backrest with at least one body-side backrest segment and at least one adjacent backrest segment, wherein at least one of the backrest segments in the released state is foldable from a use position into a non-use position, or vice versa, the adjustment device comprising:
a spring unit arranged between the adjacent backrest segments, said spring unit being in a mechanical interaction with said backrest segments.

2. The adjustment device as claimed in claim 1, wherein the spring unit is pretensioned by the mechanical interaction in a locked state of the adjacent backrest segments into the use position thereof.

3. The adjustment device as claimed in claim 1, wherein, when the adjacent backrest segment is released from the use position, the spring unit is relaxed such that the released backrest segment moves relative to the body-side backrest segment.

4. The adjustment device as claimed in claim 1, wherein, when the body-side backrest segment is released from the use position, the spring unit relaxes such that the two backrest segments move.

5. The adjustment device as claimed in claim 1, wherein the spring unit is pretensioned in the non-use position by means of the mechanical interaction in a locked state of the body-side backrest segment.

6. The adjustment device as claimed in claim 1, further comprising a body-side backrest segment driver and an adjacent backrest segment driver wherein the spring unit engages or is engageable with each of the body-side backrest segment driver and the adjacent backrest segment driver to produce the mechanical interaction.

7. The adjustment device as claimed in claim 6, wherein the body-side backrest segment driver is fastened to the body-side backrest segment and the adjacent backrest segment driver is fastened to the adjacent backrest segment.

8. The adjustment device as claimed in claim 7, wherein the spring unit comprises a spiral spring which is tensionable in two directions and an angled spring end engaging the body-side backrest segment driver and the adjacent backrest segment driver.

9. The adjustment device as claimed in claim 8, wherein the body-side driver has, at a spring-side end, two opposite stops engaging the spring end of the spring unit whereby the body-side driver tensions the spring unit during a pivoting movement of the body-side backrest segment from the use position into the non-use position and vice versa.

10. The adjustment device as claimed in claim 9, wherein the two stops are arranged spaced apart from each other forming a clearance.

11. The adjustment device as claimed in claim 9, wherein the spring unit runs against the stops in a region of a reversal from the use position into the non-use position or vice versa.

12. The adjustment device as claimed in claim 6, wherein the adjacent backrest segment driver has, at a spring-side end, a third stop, whereby the adjacent backrest segment driver tensions the spring unit during the pivoting movements of the adjacent backrest segment from the non-use position into the use position.

13. A seat arrangement for a vehicle, the seat arrangement comprising:
a seat part;
a divided backrest comprising a body-side backrest segment and an adjacent backrest segment, wherein at least one of the backrest segments in a released state is foldable from a use position into a non-use position, or vice versa; and
an adjustment device comprising a spring unit arranged between the adjacent backrest segments, said spring unit being in a mechanical interaction with said backrest segments.

14. The set arrangement as claimed in claim 13, further comprising a body-side backrest segment driver and an adjacent backrest segment driver wherein the spring unit engages or is engageable with each of the body-side backrest segment driver and the adjacent backrest segment driver to produce the mechanical interaction, wherein:
the spring unit is pretensioned by the mechanical interaction in a locked state of the adjacent backrest segment into the use position thereof;
the adjacent backrest segment is released from the use position, the spring unit is relaxed such that the released backrest segment moves relative to the body-side backrest segment;
when the body-side backrest segment is released from the use position, the spring unit relaxes such that the two backrest segments move; and
the spring unit is pretensioned in the non-use position by the mechanical interaction in a locked state of the body-side backrest segment.

15. The set arrangement as claimed in claim 14, wherein the body-side backrest segment driver is fastened to the body-side backrest segment and the adjacent backrest segment driver is fastened to the adjacent backrest segment.

16. The set arrangement as claimed in claim 15, wherein the spring unit comprises a spiral spring which is tensionable in two directions and an angled spring end engaging the body-side backrest segment driver and the adjacent backrest segment driver.

17. The set arrangement as claimed in claim 16, wherein the body-side driver has, at a spring-side end, two opposite stops engaging the spring end of the spring unit whereby the body-side driver tensions the spring unit during a pivoting movement of the body-side backrest segment from the use position into the non-use position and vice versa.

18. The set arrangement as claimed in claim 17, wherein the two stops are arranged spaced apart from each other forming a clearance.

19. The set arrangement as claimed in claim 18, wherein the spring unit runs against the stops in a region of a reversal from the use position into the non-use position or vice versa.

20. The set arrangement as claimed in claim 14, wherein the adjacent backrest segment driver has, at a spring-side end, a third stop, whereby the adjacent backrest segment driver tensions the spring unit during the pivoting movements of the adjacent backrest segment from the non-use position into the use position.
